(19) United States
(12) Patent Application Publication
(10) Pub. No.: US 2012/0265615 A1
(43) Pub. Date: Oct. 18, 2012

(54) CLICK TO CHAT IN ONLINE ADVERTISING

(75) Inventors: Viswanathan Munisamy, Chennai (IN); Thiruvel Thirumoolan, Vaithikuppam (IN)

(73) Assignee: Yahoo! Inc., Sunnyvale, CA (US)

(21) Appl. No.: 13/086,718

(22) Filed: Apr. 14, 2011

(51) Int. Cl. G06Q 30/00

(52) U.S. Cl. 705/14.58; 705/14.73; 705/14.49

(57) ABSTRACT

Techniques are provided for enabling chat in connection with online advertisements or sponsored search advertisements. Techniques are provided in which at least some sponsored search advertisements are associated with a displayed graphic, which graphic may visually suggest chat functionality. If the user selects or clicks on the graphic, without requiring opening of a Web page, a chat area may be provided, such as through the use of an instant messaging application. Using the chat area, the user may be immediately able to converse with the advertiser or an agent of the advertiser regarding a subject of the sponsored search advertisement.

### BACKGROUND

In sponsored search advertising, a user typically views a set of sponsored advertisements, or sponsored links, and may select or click on a sponsored advertisement to go to a URL associated with the advertisement, for example. However, a user's ability to interact with the advertiser, or an agent of the advertiser, is generally limited or not optimal.

There is a need for improved or better techniques in online advertising.

### SUMMARY

Some embodiments of the invention provide systems and methods for enabling chat in connection with sponsored search advertisements. Techniques are provided in which at least some sponsored search advertisements include or are associated with a displayed graphic, which may visually suggest chat functionality. If the user selects or clicks on the graphic, without requiring opening of a Web page, a chat area may be provided, such as through the use of an instant messaging application. Using the chat area, the user may immediately be able to converse with the advertiser or an agent of the advertiser regarding a subject of the sponsored search advertisement.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

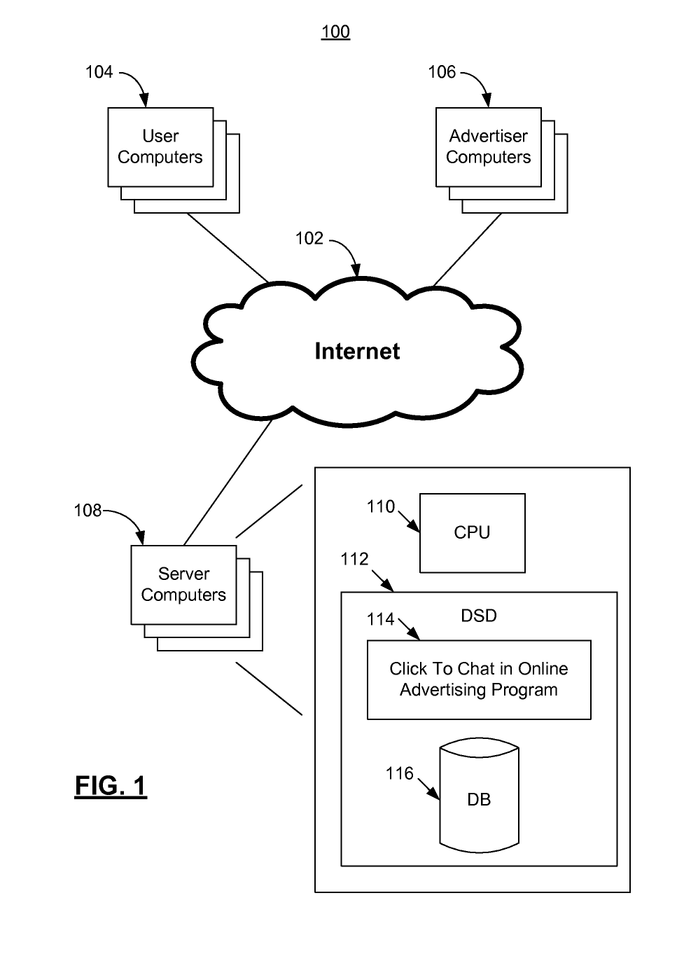

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, tablets, notebooks, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device (DSD), and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The DSD 112 includes a database 116 and a Click to Chat in Online Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

Herein, the term “advertiser” is broadly intended to include agents, proxies and representatives of advertisers, etc.

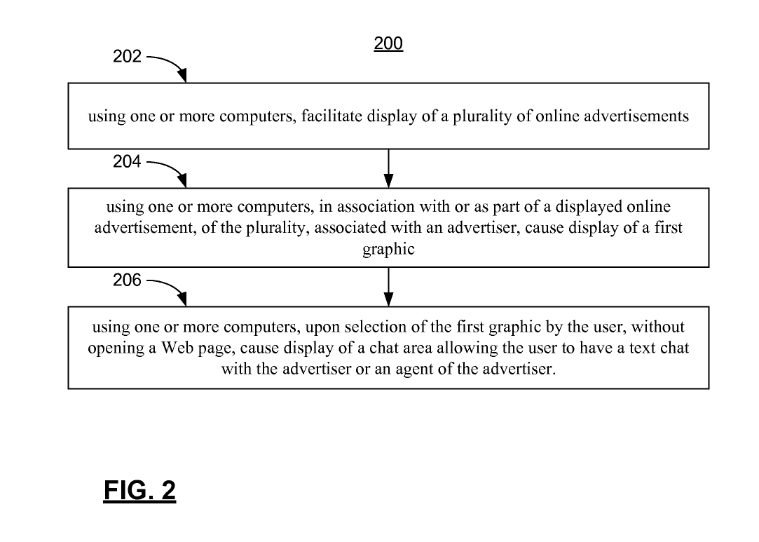

FIG. 2 is a flow diagram illustrating a method 200 according to one embodiment of the invention. At step 202, the method 200 includes, using one or more facilitating display of a plurality of online advertisements. The online advertisements could be sponsored search advertisements, non-search related advertisements including graphical or banner advertisements, etc.

At step 204, the method 200 includes, using one or more computers, in association with or as part of a displayed online advertisement, of the plurality, associated with an advertiser, causing display of a first graphic.

At step 206, the method 200 includes, using one or more computers, upon selection of the first graphic by the user, without opening a Web page, causing display of a chat area allowing the user to have a text chat with the advertiser or an agent of the advertiser.

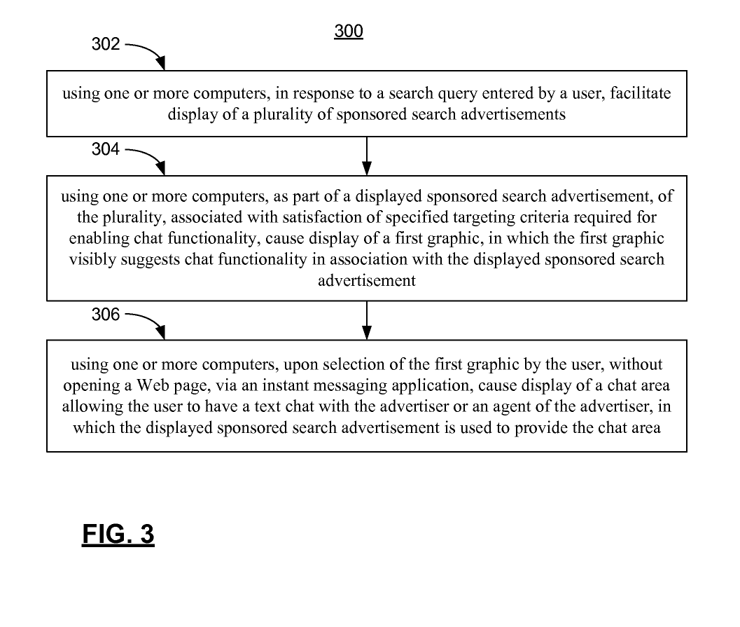

FIG. 3 is a flow diagram illustrating a method 300 according to one embodiment of the invention. At step 302, the method 300 includes, using one or more computers, in response to a search query entered by a user, facilitating display of a plurality of sponsored search advertisements.

At step 304, the method 300 includes, using one or more computers, as part of a displayed sponsored search advertisement, of the plurality, associated with satisfaction of specified targeting criteria required for enabling chat functionality, causing display of a first graphic, in which the first graphic visibly suggests chat functionality in association with the displayed sponsored search advertisement.

At step 306, the method 300 includes, using one or more computers, upon selection of the first graphic by the user, without opening a Web page, via an instant messaging application, causing display of a chat area allowing the user to have a text chat with the advertiser or an agent of the advertiser, in which the displayed sponsored search advertisement is used to provide the chat area.

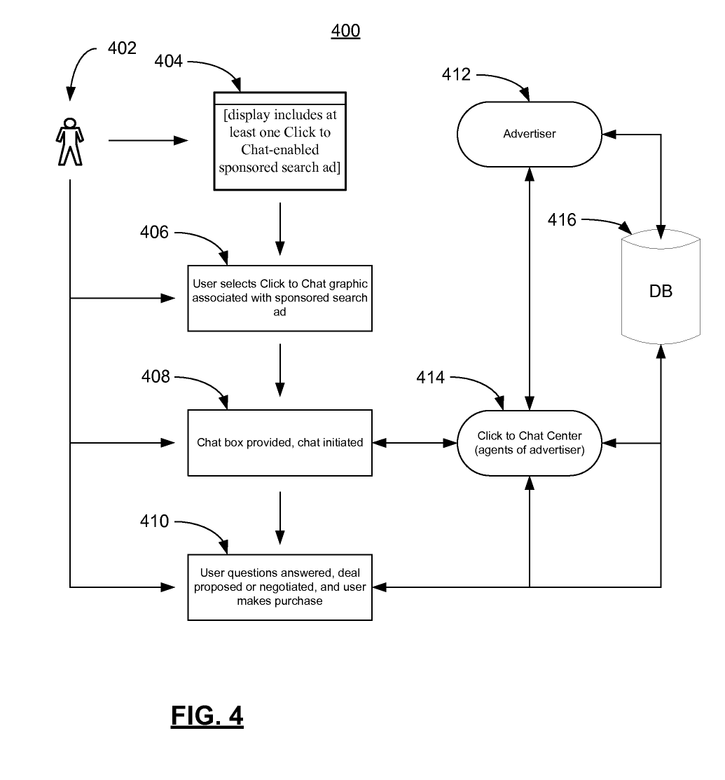

FIG. 4 is a block diagram 400 illustrating one embodiment of the invention. A user 402 is depicted, viewing the results of an entered search query on a computer screen display 404. The display includes, among other things that are not depicted, set of sponsored search advertisements (each of which may, for example, include a title, creative and link), at least one of which is enabled for click to chat functionality. Such an enabled sponsored search result may include, or be adjacent to or otherwise associated with, a displayed graphic. The displayed graphic may visually suggest chat functionality.

Block 406 represents the user 402 selecting a graphic associated with a click to chat-enabled sponsored search advertisement, such as to have a chat with an advertiser or an agent of the advertiser regarding a subject of the sponsored search advertisement.

Block 408 represents, upon selection of the graphic by the user 402, display of a chat box or other type of chat area, and initiation of a text chat between the user and an agent of the advertiser regarding a subject of the sponsored search advertisement. As depicted, an advertiser 412, associated with the sponsored search advertisement, is partnered with a click to chat center, which functions as an agent or agents of the advertiser, handling click to chat text chats with users. The advertiser 412 and the call center 414 may store and share information in one or more databases 416, and information from various stages depicted in FIG. 4 may be collected and stored in the one or more databases 416, or elsewhere.

As represented by block 410, a two-way chat occurs between the user and a call center agent. During the chat, the user or agent may ask questions and receive answers. Additionally, deals, discounts, offers, counter-offers, negotiations, etc., may occur. Such interactions can allow real-time negotiations based on current information and/or based on information or developments occurring in the chat itself. As depicted, the chat may culminate in the user making a purchase or some other type of conversion, which may occur through the chat, partially through the chat, or outside the chat.

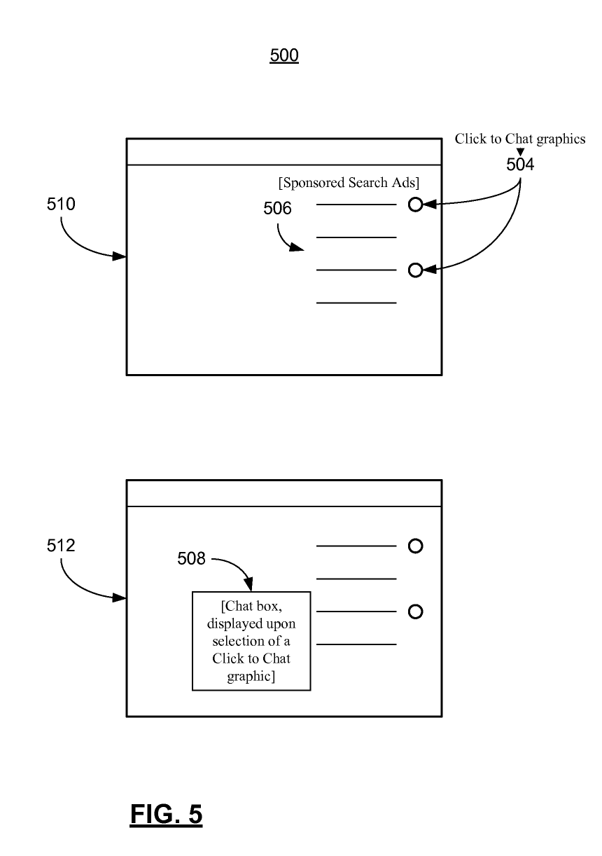

FIG. 5 is a block diagram 500 illustrating one embodiment of the invention. Block 510 represents a computer (or other device) display, including, among other things not depicted, a set of sponsored search advertisements 506, at least some of which are click to chat-enabled and include graphics 504.

As represented by block 512, upon user selection of a graphic associated with a particular sponsored search advertisement, a chat box is provided, to allow a chat between the user and an advertiser associated with the particular sponsored search advertisement, such as regarding a subject of the advertisement.

Although various types of chat are contemplated, in some embodiments, the chat can utilize or be through an instant messaging application, such as Yahoo! Messenger, MSN Messenger, etc. This could include many forms and be accomplished in many ways. For example, the chat could take place inside or as part of a display, banner, or sponsored search advertisement. Such chat functionality might be facilitated or enabled, for example, by utilizing a small JavaScript chat code associated with the instant messaging application, or in other ways.

As mentioned above, in some embodiments, some or all of a set of sponsored search listings may be chat-enabled, with a user-selectable chat graphic, such as an icon. In some embodiments, various factors or characteristics of sponsored search advertisements may be used in determining whether to enable particular advertisements. For example, in some embodiments, only advertisements relating to sales may be enabled. As another example, advertisements may only be enabled if the associated advertiser has chosen to participate, has registered, etc. Furthermore, in some embodiments, advertisements may only be chat-enabled if certain keywords are associated with the advertisement, or with the user query, such as “buy”, “shop”, etc.

In some embodiments of the invention, chat-enabled advertisements make it easier for the advertiser to reach the consumer. Chat-enabled advertisements, accordingly to embodiments of the invention, can allow an end user to interact with the advertiser or agent to know more about a product, get a better deal for a product that the user is searching for, etc. For example, providing a chat icon with the search results can enable the user interactively chat with the advertiser, which can increase the chances for the advertiser to get a lead, sale, conversion, action, engagement, etc.

In some embodiments, advertisers, when registering their creatives, for example, may sign up for the click to chat option. In some embodiments, click to chat enablement can be at a premium to an advertiser, or to bidding, and could be charged in many ways and using many models. For example, every click on the chat icon could require a premium bid in addition to a base bid value.

In some embodiments, when an end user searches for a product, and if the advertiser or agent has signed up for the “Click to Chat” option, a chat icon will be displayed as a part of a creative. If the end user is interested in a chat with the advertiser or agent, the user clicks on the icon and can have an instant conversation with the advertiser.

In some embodiments, if the advertiser or agent(s) is geographically distributed, the particular advertiser representative or agent connected to a chat can be based on geography or other factors. For example, based on a location associated with the IP address of the end user, a nearby store will be chosen to participate in a chat. This can enable the end user to get desirable local deals instead of less desirable contact with a representative or agent who is remote from the user.

In some embodiments, location based metrics, such as performance metrics associated with click to chat, may be tracked, collected or determined and provided to the advertiser. The advertiser may use such metrics and reporting, for example, to refine an advertising campaign, such as by focusing primarily on high performing locations.

Some embodiments of the invention bring an advertiser and end user closer than ever. The chances of converting a lead to a customer can increase. Instead of the end user being sent to a Web page, end users can directly chat with the advertiser, which can provide a better lead for the advertiser.

In some embodiments, the end user may interact in a chat in such a way that the advertiser or agent involved in the chat is aware of the user's identity or profile, or may chat anonymously. For example, in some embodiments, the end user can interact, or may opt to interact, with the advertiser as an anonymous user, thereby not disclosing any or too much personal information or other details desired to be kept confidential, at least until the user is ready.

Some embodiments of the invention provide a way to effectively use and monetize chat platforms and applications, which may be used in providing the chat.

In some embodiments, advertisers, such as large advertisers, may use their existing customer care centers. For example, chat duties can be divided between customer support divisions. For example, this may help enable each support person to handle more than one user simultaneously.

In some embodiments, advertisers or agents can be allowed to set various settings or thresholds in connection with click to chat-enabled advertisements. For example, in some embodiments, an advertiser or agent can cause chat icons to be shown for particular locations only until a particular set limit is met.

In some embodiments, graphics may be displayed in association with search results, instead of sponsored search results, such as for simplicity.

In some embodiments, for local advertisers, click to chat enablement can be turned off if the user receiving the advertisement is not in the local area.

In some embodiments, it is not necessary to open a Web page in order to provide a chat area and function. Furthermore, in some embodiments, it is not necessary to open a new window. For example, in some embodiments, the sponsored search advertisement itself can be used in providing the chat area and function, which may provide advantages, such as causing less or no coverage of other displayed items on the screen.

In some embodiments, click to chat-enabled advertisements provide advertisers with great flexibility, enabling real-time interaction with user, to provide special deals and enticements, etc. Furthermore, some embodiments of the invention allow advertisers to use different business models. For example, in some embodiments, advertisers may utilize servers, etc. but may not even need a Web site.

While the invention is described with reference to the above drawings, the drawings are intended to be illustrative, and the invention contemplates other embodiments within the spirit of the invention.

1. A method comprising:
using one or more computers, facilitating display of a plurality of online advertisements;
using one or more computers, in association with or as part of a displayed online advertisement, of the plurality, associated with an advertiser, causing display of a first graphic; and
using one or more computers, upon selection of the first graphic by the user, without opening a Web page, causing display of a chat area allowing the user to have a text chat with the advertiser or an agent of the advertiser.

2. The method of claim 1, wherein facilitating display of a plurality of online advertisements comprises, in response to a search query entered by a user, facilitating display of a plurality of sponsored search advertisements, and wherein the displayed online advertisement is a displayed sponsored search advertisement.

3. The method of claim 2, comprising displaying first graphic as part of the displayed sponsored search advertisement, and wherein the chat is in connection with the displayed sponsored search advertisement.

4. The method of claim 2, comprising displaying the first graphic adjacent to the displayed sponsored search advertisement.

5. The method of claim 2, comprising displaying the first graphic, wherein the first graphic visibly suggests chat functionality in association with the displayed sponsored search advertisement.

6. The method of claim 2, comprising allowing the user to have the chat, wherein the chat provides an opportunity for the user, and the advertiser or the agent of the advertiser, to negotiate regarding a potential purchase by the user, wherein the potential purchase is associated with the sponsored search advertisement.

7. The method of claim 2, comprising allowing the user to have the chat, wherein the chat provides an opportunity for the advertiser or the agent of the advertiser to offer or provide, in real time, one or more deals, discounts, or coupons to the user.

8. The method of claim 2, comprising allowing the chat utilizing an instant messaging application.

9. The method of claim 2, comprising allowing the chat, wherein the displayed sponsored search advertisement is used to provide the chat area.

10. The method of claim 2, comprising enabling chat functionality only for sponsored search advertisements satisfying specified criteria.

11. The method of claim 2, comprising enabling chat functionality only for sponsored search advertisements satisfying specified targeting criteria.

12. The method of claim 2, comprising enabling chat functionality only for sponsored search advertisements satisfying specified geotargeting criteria.

13. The method of claim 2, comprising enabling chat functionality only for sponsored search advertisements displayed to users that are determined to be sufficiently geographically proximate to an advertiser or an agent of an advertiser.

14. The method of claim 2, comprising allowing the chat, wherein the user is allowed to chat anonymously.

15. The method of claim 2, comprising allowing the user to have a text chat, wherein the chat is with the advertiser or an agent of the advertiser selected based at least in part on the location of the user.

16. A system comprising:
one or more server computers coupled to a network; and
one or more databases coupled to the one or more server computers;
wherein the one or more server computers are for:
in response to a search query entered by a user, facilitating display of a plurality of sponsored search advertisements;
in association with or as part of a displayed sponsored search advertisement, of the plurality, associated with an advertiser, causing display of a first graphic; and
upon selection of the first graphic by the user, without opening a Web page, causing display of a chat area allowing the user to have a text chat with the advertiser or an agent of the advertiser.

17. The system of claim 16, wherein at least one of the one or more server computers are coupled to the Internet.

18. The system of claim 16, comprising displaying the first graphic, wherein the first graphic visibly suggests chat functionality in association with the displayed sponsored search advertisement.

19. The system of claim 16, comprising allowing the user to have the chat, wherein the chat provides an opportunity for the user, and the advertiser or the agent of the advertiser, to negotiate regarding a potential purchase by the user, wherein the potential purchase is associated with the sponsored search advertisement.

20. A computer readable medium or media containing instructions for executing a method comprising:
using one or more computers, in response to a search query entered by a user, facilitating display of a plurality of sponsored search advertisements;
using one or more computers, as part of a displayed sponsored search advertisement, of the plurality, associated with satisfaction of specified targeting criteria required for enabling chat functionality, causing display of a first graphic;
wherein the first graphic visibly suggests chat functionality in association with the displayed sponsored search advertisement; and
using one or more computers, upon selection of the first graphic by the user, without opening a Web page, via an instant messaging application, causing display of a chat area allowing the user to have a text chat with the advertiser or an agent of the advertiser, wherein the displayed sponsored search advertisement is used to provide the chat area.
